(19) United States
(12) Patent Application Publication
(10) Pub. No.: US 2025/0256226 A1
(43) Pub. Date: Aug. 14, 2025

(54) Variable Filter Media Thickness for Improved Flow and Filter Performance

(71) Applicants: Baldwin Filters, Inc., Cleveland, OH (US); Parker-Hannifin Corporation, Cleveland, OH (US)

(72) Inventors: Jason L. Tate, Kearney, NE (US); Simon Padron, Columbia, TN (US)

(73) Assignees: Baldwin Filters, Inc., Cleveland, OH (US); Parker-Hannifin Corporation, Cleveland, OH (US)

(21) Appl. No.: 19/194,681

(22) Filed: Apr. 30, 2025

Related U.S. Application Data
(63) Continuation of application No. PCT/US2023/033790, filed on Sep. 27, 2023.
(60) Provisional application No. 63/505,470, filed on Jun. 1, 2023.
(60) Provisional application No. 63/423,824, filed on Nov. 9, 2022.

(51) Int. Cl. B01D 29/23; B01D 46/52

(52) U.S. Cl. CPC B01D 29/232; B01D 46/522; B01D 2201/12

(57) ABSTRACT

Thicker and thinner portions of a filter media sheet are provided in a filter element. The filter element includes a ring of filter media disposed around a central support tube. The filter media comprising a pleated layer of media including inner pleat tips adjacent the tube, and outer pleat tips radially outwardly spaced from the tube. The layer varies in thickness between the tips, such that a thinner portion of media is at the inner pleat tips than as at the outer pleat tips.

### CROSS-REFERENCE TO RELATED PATENT APPLICATIONS

This patent application is a Continuation of co-pending U.S. PCT Patent Application No. PCT/US2023/033790, filed Sep. 27, 2023, which claims the benefit of U.S. Provisional Patent Application No. 63/505,470, filed Jun. 1, 2023, and U.S. Provisional Patent Application No. 63/423,824, filed Nov. 9, 2022, the entire teachings and disclosure of each of these patent applications are incorporated herein by reference thereto.

### FIELD OF THE INVENTION

This invention generally relates to pleated filter media sheet arrangements, such as may be incorporated into filter media rings that may be supported by an inner support tube.

### BACKGROUND OF THE INVENTION

Filter media is often pleated to improve surface area for improved filtration performance in a compact space. In many applications, the media is wrapped around a perforated center tube to create an annular shape. The center tube provides structure to the assembly during use as fluid flow creates a differential pressure across the filter media. The amount of usable filter media in this type of assembly is limited to the collective pleat tip widths at the inside diameter around the center tube.

In the art, proposals to provide beads and/or form embossments have been made in different pleated filter media arrangements, for example as may be seen in the following patent publications DE102015006355A1, U.S. Ser. No. 10/632,412B2, WO02055179A1, US20140202123A1, and DE4345130C1 (see also Li et al., Research on the Filtration Performance of Pleated Filters with Rectangular and Triangular Structures Through Developed Cfd Code, https://papers.ssm.com/sol3/papers.cfm?abstract_id=4126929, posted Jun. 3, 2022).

Such prior attempts can either limit or reduce filtration capacity such as due to adhesive beads obstructed media, and/or can limit the amount of media, or add additional complexities.

The present disclosure and embodiments herein provide different and new solutions to increasing flow area, especially in embodiments where the media is wrapped into an annular shape. These and other advantages of the invention, as well as additional inventive features, will be apparent from the description of the invention provided herein.

### BRIEF SUMMARY OF THE INVENTION

The subject invention reduces the filter media thickness at the inside diameter pleat tips, thereby allowing for more useable filter media surface area across the filter, which improves performance.

This type of technology is not currently utilized in the filtration industry. Pleated annular assemblies have been used in the industry for decades. Generally, the media layer has a uniform thickness which is then folded to form pleats.

Pleats are primarily created using rotary nip rollers with projecting scoring bars protruding from the nip rollers that create the folded pleat. The height of the pleat is a direct association to the spacing of the score bars around the nip roller. According to one embodiment, an increase in base roller diameter from one score bar to the next such that the media is compressed in progressive pressure from nominal pressure at one score to high pressure at the next. According to another embodiment using a flat press (see e.g. U.S. Pat. No. 11,235,270, which is incorporated by reference in its entirety), reciprocating die plates shape media with every up and down reciprocation while the media is advanced between die plates. This allows for the variable base media compression with less tooling complexity.

An aspect of the present invention is directed toward a filter element including a ring of filter media disposed around a central support tube. The filter media comprises a pleated layer of media including inner pleat tips adjacent the tube, and outer pleat tips radially outwardly spaced from the tube. The layer varies in thickness between the tips, such that a thinner portion of media is at the inner pleat tips than as at the outer pleat tips.

Another aspect of the present invention is directed to a filter media sheet including a pleated layer of filter media including for pleat tips at opposite first and second flow faces. The pleated layer includes a thinner portion of filter media extending from the pleat tips at the first flow face toward the second flow face, and a thicker portion of filter media extending from the pleat tips at the second flow face toward the first flow face, the thicker portion being thicker than the thinner portion.

In this above filter media sheet aspect, the filter media sheet may be used in a filter element in which the filter media sheet is wrapped into a ring and defines a central cavity, with a radial inner periphery of the ring being provided by the pleat tips at the first flow face (i.e., inner pleat tips) and a radial outer periphery of the ring being provided by the pleat tips at the second flow face (i.e., outer pleat tips) radially spaced outward from the inner radial periphery.

Yet another aspect of the present invention is directed toward a method of creating a filter media pack, comprising: creating thicker and thinner portions of a filter media sheet, the thicker portions being thicker than the thinner portions; folding the filter media sheet at the thinner portions; folding the filter media sheet at the thicker portions, thereby creating pleats between folds at the thinner and thicker portions; and wrapping the filter media pack into an annular shape with the thinner portions at an inner radial periphery and thicker portions being at the outer radial periphery.

Any of these above aspects may be used in connection with one or more features either alone or in combination with each in the below paragraphs.

It is a feature that pleat scores may be provided at inner pleat tips and at outer pleat tips, with the thinner portion of media being adjacent to the pleat scores of the inner pleat tips as compared to a thicker portion of media being adjacent to pleat scores of the outer pleat tips. Preferably, outside of the pleat scores, the thinner portion may have a minimum thickness that is 20% to 90% thinner than a maximum thickness of the thicker portion.

It is a feature that the filter media may have a progressively increasing thickness as the filter media extends radially outwardly from inner pleat tips to outer pleat tips. Optionally, the progressively increasing thickness may also continuously vary as the filter media extends radially outwardly.

It is a feature that the filter media may vary in thickness in a stepped manner as the filter media extends radially outwardly from inner pleat tips to the outer pleat tips.

It is a feature that preferably, there are at least one radially extending segment of constant thickness in the thicker portion (e.g., unmodified thickness) as the thicker portion extends radially inward from the outer pleat tips; and optionally the thinner portion may have a radially extending segment of constant thickness.

It is a feature that the thicker portion of media is provided that is thicker than the thinner portion in that the thinner portion may be 20% to 90% thinner than a maximum thickness of the thicker portion.

It is a feature that the filter media may comprise: a pleat depth extending between the inner pleat tips and the outer pleat tips between 0.9 and 7.7 centimeters; a maximum caliper thickness of between 0.2 and 5.1 millimeters.

It is a feature that the central support tube may be used which may have an outer diameter of between 1 and 40 centimeters.

It is a feature that the thinner portion may remain substantially constant in thickness across a span of the ring of filter media, the span being parallel to the pleat tips.

It is a feature that the filter media may free of embossments, having opposite generally flat surfaces intermediate of the pleat tips.

It is a feature that the thinner portion may extend between 5% and 50% of a pleat depth of the pleated layer, and preferably between 10% and 30% of the pleat depth of the pleated layer. Preferably the thinner portion is only provided within the inner half of the pleat depth.

It is a feature that the thinner portion creates space at an inner periphery of the ring to provide larger flow gaps between adjacent inner pleat tips and/or more filter media being used in the ring with more pleats (in comparison to the same arrangement except for the thinner portion being used—see e.g., a comparison of FIGS. 2 and 3).

It is a feature that the thinner portion may merge into the thicker portion as the thinner portion extends radially outwardly perpendicular to the inner pleat tips.

It is a feature that the thinner portion has a minimum thickness that is 20% to 90% thinner than a maximum thickness of the thicker portion. Preferably, pleat scores are provided at the pleat tips, with the thinner and thicker portions of the filter media extending from respective pleat scores.

It is a feature that the filter media may have a progressively increasing thickness as the filter media extends perpendicularly from the pleat tips at the first flow face to the pleat tips at the second flow face.

It is a feature that the filter media may vary in thickness in a stepped manner as the filter media extends perpendicularly from the pleat tips at the first flow face to the pleat tips at the second flow face.

It is a feature that the filter media may have a progressively increasing tapered thickness over at least a segment of pleat depth as the filter media extends perpendicularly from the pleat tips at the first flow face to the pleat tips at the second flow face.

It is a feature that the method for making the filter pack and/or filter element (i.e., production method) may score the filter media pack at first scores intermediate of the thinner portions and second scores intermediate of the thicker portions, with folding is facilitated along the first and second scores.

It is a feature that the production method may convey the filter media sheet along an advancing path to a plate die press or cooperating rolls; compress the filter media sheet with plate die press or cooperating rolls to reduce a thickness of the filter media sheet between 20 and 90% over a region of between 5% and 50% of a pleat depth of the pleats, and more preferably between 10% and 30% of the pleat depth.

It is a feature that the production method may employ the cooperating rolls having an eccentric therebetween that compresses the filter media sheet to a variable thickness. Alternatively, the method may employ the plate die press, wherein the plate die press comprises a variable thickness gap between opposing plates compressing the filter media sheet along the pleats to a variable thickness between folds.

It is a feature that the pleated layer may comprise only a single ply (for example, single deposition of fibers).

Alternatively, the pleated layer may be a composite comprising at least two plies including first and second plies laminated together, optionally with the first and second plies having different filtration properties.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exemplary cross-section of a symmetrical/cylindrical filter element incorporating a ring of filter media according to an embodiment of the present invention, along a plane extending along/coincident with a central axis of the filter;

FIG. 2 is a cross section of the ring of filter media and central support tube portion of the filter element of FIG. 1 showing thicker and thinner portions, the cross section being perpendicular to the central axis of the filter;

FIG. 3 is a view similar to FIG. 2 except showing the filter media without thicker and thinner portions, but a constant caliper thickness;

FIG. 4 is a partly schematic side/cross section view of a flat press assembly according to an embodiment for forming the filter media sheet with thicker and thinner portions useable in the filter element of FIGS. 1 and 2;

FIG. 5 is a partly schematic side/cross section view of a roll die assembly according to an alternative embodiment to that of FIG. 4 also for forming the filter media sheet with thicker and thinner portions useable in the filter element of FIGS. 1 and 2; and

FIG. 6 is an isometric view of a formed sheet with thicker and thinner portions useable in the filter element of FIGS. 1 and 2.

FIG. 7 is an isometric view of a formed sheet with thicker and thinner portions useable in the filter element of FIGS. 1 and 2 similar to that of FIG. 6 but with steps having delineation between thicker and thinner portions and radially extending segments of constant thickness joined by a tapered segment of the thinner portion.

FIG. 8 is a cross section of filter media and central support tube portion of the filter element the same as FIG. 2 showing thicker and thinner portions, except according to an alternative embodiment with a filter media layer being a composite media having multiple plies.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

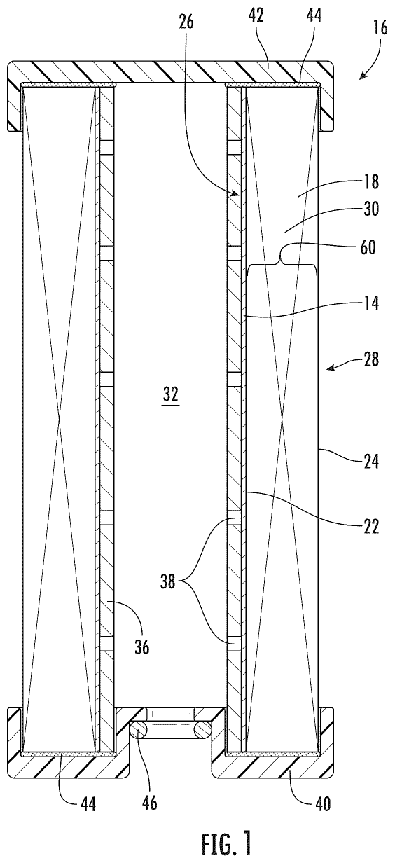

As shown in FIGS. 1-2 and 6, thicker and thinner portions 10, 12 of a filter media sheet 14 are provided in a filter element 16, in accordance with an embodiment of the present invention.

The filter media sheet 14 includes a pleated layer of filter media 18 providing a plurality of pleats 20 that each extend between first/inner pleat tips 22 and second/outer pleat tips 24. When arranged into a filter media pack, the first/inner pleat tips 22 are arranged adjacent to form a first/inner flow face 26 and second/outer pleat tips 24 are arranged to form a second/outer flow face 28.

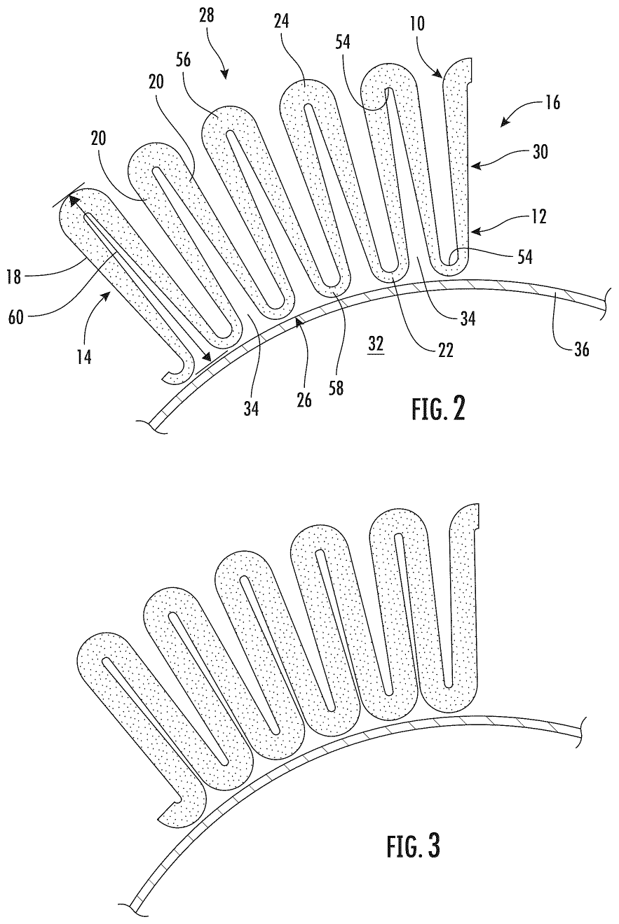

The arrangement could be used in a panel type element but are most advantageous as shown in FIGS. 1 and 2 when arranged into a ring 30, in which the pleated layer of filter media 18 is wrapped about a central cavity 32, with opposed cut ends of the filter media sheet 14 joined to each other. Such filter media ring arrangements for which this may be employed are shown for example in any of the following U.S. patent or Patent Publications: U.S. Pat. Nos. 4,872,976A, 5,078,877A, 5,484,466A, US20030015465A1, US20070084170A1, US20070163945A1, and U.S. Pat. No. 7,740,679B2 (all of these patents/patent publications are incorporated by reference in their entireties as examples for which the filter media sheet 14 of the present application can be used to provide a ring of filter media). The features of this are applicable to different types of fluids, for example, both air filters and liquid filters.

As shown in FIGS. 2 and 6, 7 (e.g. in comparison to FIG. 3) the pleated layer of filter media 18 varies in thickness as the media extends perpendicularly between the inner and outer pleat tips 22, 24, such that the thinner portion 12 of filter media extends from the pleat tips 22 at the first/inner flow face 26 toward the second/outer flow face 28; and the thicker portion 10 of filter media extends from the second/outer pleat tips 24 at the second/outer flow face 28 toward the first/inner flow face 26.

As apparent from the illustration, the thicker portion 10 of each pleat 30 is thicker than the thinner portion 12 of each pleat 30. As the thinner portion 12 extends radially outwardly and perpendicular to the inner pleat tips 22, the filter media of the pleated layer stops being thinner at some point and becomes thicker at the thicker portion 10; and as such the thinner portion 12 merges into the thicker portion as the filter media extends radially outward as shown in FIG. 2 and FIGS. 6 and 7.

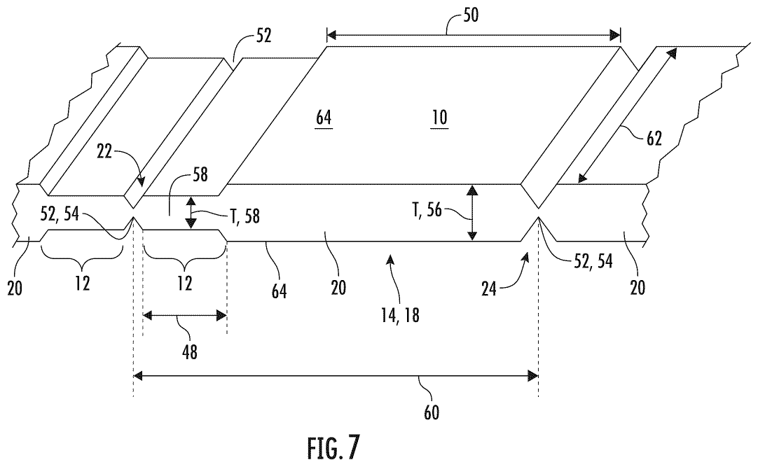

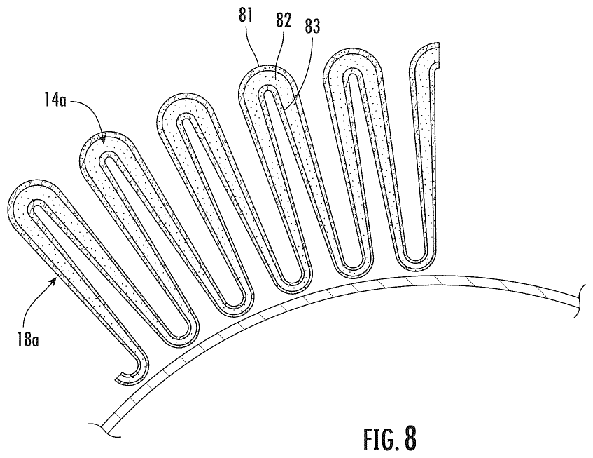

The thickness of the filter media sheet 14 may also continuously vary as shown best in FIG. 6, however it is also envisioned that the variance may only be over a portion of the filter media sheet 14, particularly in a region adjacent to the first/inner pleat tips 22 at the first/inner flow face 26, such as shown in FIG. 7.

As can be seen in comparing FIGS. 2 and 3, this can create increased flow gaps 34 for improved flow area as a result of the reduced thickness. This can lower the pressure drop and provide longer filter life when employed in a filter media arrangement according to FIG. 1.

Alternatively, and/or in addition, the thinner portion 12 can provide the ability to pack more filter media into a ring shape such that the number of inner pleat tips 22 (e.g. surrounding a filter support tube 26) can be increased because there is more room for additional inner pleat tips due to the thinner media portion 12 creating more room at the inner periphery. As a result, there can be packed more pleats and hence more filter media that allows for increased filtration capacity as there is more available surface area for fluid to pass through and for loading of filtered out particulates. Therefore, creating increased flow gaps 34 may not be accomplished in some embodiments.

For increased flow gaps and/or increased media/pleat packing, this is particularly advantageous when used in conjunction with a central support tube 36 that can predetermine the inner diameter of the pleated filter media ring 30, with the ring 30 of filter media disposed around a central support tube 36. When radially inward flow occurs (e.g. of fluid such as fuel, oil, other liquids, air or other gases), then the central support tube 26 can support and prevent inward collapse of the ring 30 of filter media, with the first/inner flow face 26 (e.g. the inner pleat tips 22) contacting the support tube 36 when support is needed due to fluid flow and pressure differential.

The central support tube 26 is porous, for example perforated by a plurality of flow holes 38 to allow the fluid to pass radially inward into the central cavity 32 and along the central axis of the filter element 16.

The filter element 16 may further include opposite end caps such as open end cap 40 and closed end cap 42, that can be integrally bonded to opposing ends of the ring 30 of filter media and integrally bonded to the central support tube 26 at opposite ends (for example such as through adhesive 44 that reside in annular wells of the end caps.

For many of the typical air or liquid filtration applications, the central support tube 26 may have an outer diameter of between 1 and 40 centimeters (and the inner diameter of the filter media ring 30 may be the same).

The open end cap 40 allows for filtered fluid to exit, and the closed end cap 42 can ensure flow is directed in the axial direction toward the opening in the open end cap 40, which may be surrounded by an annular gasket 46 that may be carried or integral with the open end cap 40 to facilitate sealing to an external mounting head, pipe and/or housing.

Returning to the nature of the varying thickness pleated filter media sheet 14, it is shown the pleat layer has thinner portion 12 and a thicker portion 10.

The thinner portion 12 has a thickness that is thinner relative to median thickness over a radially extending span in a first region 48 immediately adjacent the first/inner pleat tips 22, and thicker portion 10 with a thickness that as thick or thicker relative to median thickness over a radially extending span in a second region 50.

The pleat layer may continuously vary in thickness between pleat tips as shown in FIG. 6 or may also vary in a non-continuous manner as shown in FIG. 7 (e.g., also showing that thicker portion of media proximate the outer pleat tips can include a portion with a constant unmodified thickness and optionally a radially inward thinner portion constant compressed thickness). The thinner first region 48 stops well short of the second outer pleat tips 24. A reduced thickness of the thinner portion 12 may extend (e.g., span of reduced thickness region 48 relative to median thickness) at least 5% of the pleat depth 60 as shown in FIGS. 6 and 7. The reduced thickness region 48 of the thinner portion 12 may extend up to 50% (or potentially more) of the pleat depth 60 as shown in FIG. 6. However, the benefit of reducing crowding at the inner pleat tips benefits from the reduced thickness of the filter media sheet immediately adjacent the region of the inner pleat tips. As such, the reduced thickness region 48 of the thinner portion 12 may extend more typically between 10% and 30% of the pleat depth 60, such as shown in FIG. 7.

Optionally, the pleat layer varies in the thicker portion 10 in the second region 50 of the second outer pleat tips 24, as shown in FIG. 6. Alternatively, it may be beneficial not to compress the media in the thicker second 50 as shown in FIG. 7, wherein the thicker portion 10 and thicker second region 50 remains either all or mostly uncompressed and can establish/match the median thickness.

The span of the reduced thickness region 48 is determined to be the span from the inner pleat tip below the median thickness for the reduced thickness region 48 as shown in both alternatives of FIGS. 6 and 7. The span of the increased thickness region 50 is determined the span from the outer pleat tip at or above the median thickness as shown in both alternatives of FIGS. 6 and 7.

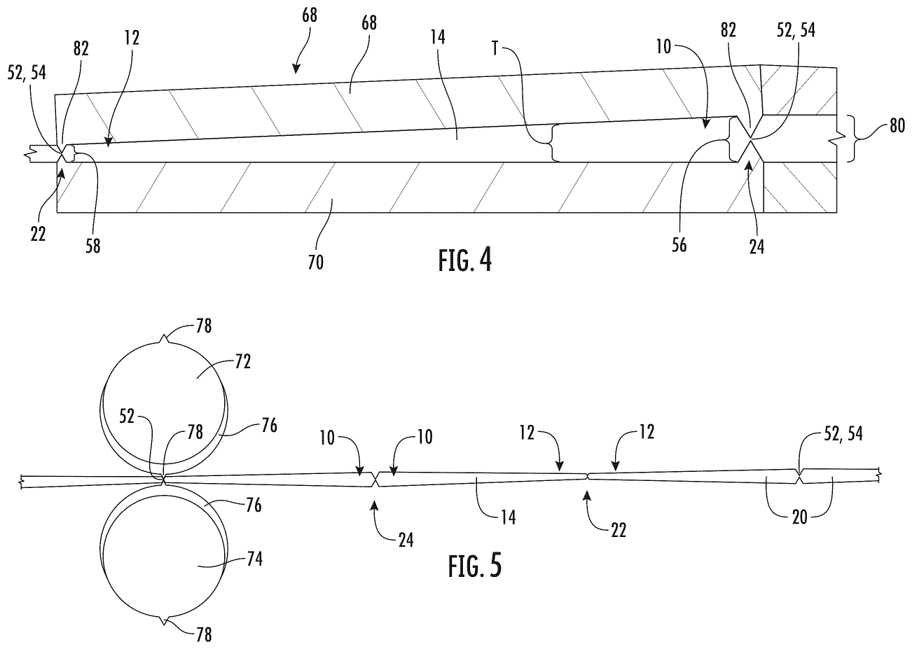

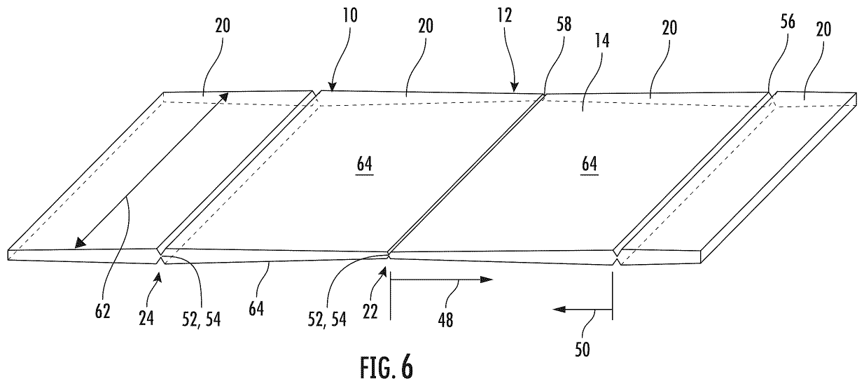

Preferably, pleat scores 52 are formed (e.g., by a score bar on rolls/flat dies as shown in FIGS. 4 and 5) to provide predetermined folding locations for the inner and outer pleat tips 22, 24, which are shown in the FIG. 6 embodiment (and are not shown in FIG. 2 and/or scores may alternatively be excluded to facilitate folding in embodiments). The scores facilitate folding creases due to weakening and/or creating weakened areas such as localized dents into the filter media sheet 14.

When pleat scores are provided at the pleat tips 22, 24 the thicker and thinner portions 10, 12 at the respective pleat tips 22, 24 extend outward from and are adjacent to the pleat scores 52.

As a result, and as used herein, thicker and thinner portions 10, 12 are determined independently of score 52 features used for folding/pleating. In other words, the pleat scores 52 are excluded in identifying and considering relative thicknesses at regions of inner and outer pleat tips 22, 24 (and similarly excluded in identifying and considering relative thicknesses of thicker and thinner portions 10, 12). Pleat scores 52 may be formed into the thicker or thinner portions 10, 12, but pleat scores 52 are therefore not considered when comparing, measuring and/or determining thicker or thinner portions 10, 12.

For example, as shown, the pleat score 52 for outer pleat tips 24 creates a very localize region/line for the fold that can be thinner than the thinner portion 12. However, the thin pleat score 52 for outer pleat tips 24 is excluded and not considered to be part of the thicker portion 10 in the sense comparing to a thinner portion 12 of the filter media sheet 14 that is at the inner pleat tips 12 (as compared to the thicker portion 10 as at the outer pleat tips 24). Similarly, the thin pleat score 52 for inner pleat tips 22 is excluded and not considered to be part of the thinner portion 12 in the sense comparisons of the thinner portion 12 to the thicker portion 10.

With these understandings and as best shown in FIGS. 6 and 7 (with scores) and FIG. 2 (without scores), the thicker portion 10 has a maximum thickness 56 that preferably may be an unmodified media thickness (or alternatively lightly reduced thickness from unmodified) typically somewhere between 0.2 millimeter and 5.1 millimeter before thickness reduction to create the thinner portion 12; and thickness reduction for the minimum thickness 58 may be between 20% and 90% of that maximum thickness 56 in creating the thinner portion 12. Preferably the thinner portion has a minimum thickness 58 that will be at least 50% less of the maximum thickness 56.

As alluded to above, the reduction in thickness is more important toward the inner pleat tips 22, and the filter media has a reduced thickness as the filter media extends in first region 48 shown from first inner flow face 26 toward the second outer flow face 28 over at least 5% of the pleat depth 60 that may be up to 50% of the pleat depth (more typically between 10% and 30% to be most beneficial for inner pleat tip crowding advantages). For example, as shown in FIG. 6, the filter media has a progressively increasing thickness as the filter media extends from inner pleat tips 22 to the outer pleat tips 24; and for example, as shown in FIG. 7, the filter media has stepped varied thickness regions.

For many of the typical pleated ring examples, such as those patents/publications referenced in patents above, the filter pack (e.g., ring 30 of pleated filter media) has a pleat depth 60 extending between the pleat tips at the first and second flow faces of between 0.9 and 7.7 centimeters.

For many of the typical pleated ring examples, such as those patents/publications referenced in patents above, the maximum caliper thickness (i.e., the same thickness as the maximum thickness 26) of the filter media sheet 14 is most typically between 0.2 and 5.1 millimeters.

While variance in the pleat depth direction is useful, there is no need to vary in the perpendicular direction (e.g., the span between the end caps 40, 42). As such, it can be seen in FIG. 6 that the thinner portion 12 may remain substantially constant (e.g., constant or variance of less than 10%) in thickness T at different locations of the first region 48 across a span 62 of the filter media sheet 14 between opposite sides (e.g., the span 62 being parallel to the pleat tips).

Further, the filter media can be free of embossments, having opposite generally flat surfaces 64 intermediate of the pleat tips 22, 24 as shown in FIG. 6 and FIG. 2. By “generally flat” it is meant free of discrete embossments that have depth greater than the thickness of the media sheet. However, the term “generally flat” allows optionally for employing “grooving/corrugating” rolls that may sometimes be used to create shallow continuous corrugations/grooves in the filter media sheet that typically run perpendicularly to pleat tips with such corrugations/grooves having groove depth typically less than the maximum thickness (e.g., unmodified thickness) of the filter media sheet.

To maximize the size of the beneficial flow gap 34, the thinner portion 12 is thinnest to proximate an apex (e.g., such as the pleat score 52 location) of the inner pleat tips 22 and expands in thickness over the first region 48 in extension at least over a part of the pleats 20 toward the outer pleat tips 24.

As shown in either FIGS. 4 and 5 (with additional reference then to FIGS. 1 and 2, a method of creating a filter media pack comprises: creating thicker and thinner portions 10, 12 of the filter media sheet 14 as by either that of FIGS. 4 and 5; folding the filter media sheet 14 at the thinner portions 12 and folding the filter media sheet 14 at the thicker portions 10, thereby creating pleats 20 between folds at the thinner and thicker portions; and wrapping the filter media pack into an annular shape (e.g. filter media ring 30) with the thinner portions 12 at an inner radial periphery and thicker portions 10 being at the outer radial periphery such apparent from FIGS. 1 and 2.

To facilitating pleating, the method preferably utilizes scoring of the filter media pack at scores 52 including first scores intermediate of the thinner portions 12 and second scores intermediate of the thicker portions 10, wherein the folding is facilitated along the first and second scores.

In FIG. 4 or 5, the method involves conveying the filter media sheet 14 along an advancing path to either a plate die press 66 (e.g. upper and lower press plates 68, 70) or a pair of cooperating rolls 72, 74. Either of these equipment can facilitate the compressing of the filter media sheet 14 with plate die press 66 or cooperating rolls 72, 74 to reduce a thickness of the filter media sheet between 20% and 90% over a region of between at least 5% and up to 50% of the pleat depth 60.

As shown in FIG. 5, the method employs the cooperating rolls 72, 74 having an eccentric 76 therebetween that compresses the filter media sheet to a variable thickness and may also have score bars 78 to facilitate the formation of scores 52.

As shown in FIG. 4, when the plate die press 66 is employed, wherein the plate die press comprises a variable thickness gap 80 between opposing plates 68, 70 compressing the filter media sheet along the pleats to a variable thickness between folds. One or both plates may also have score bars 82 to facilitate the formation of scores 52. The embodiment of FIG. 4 can be employed in the equipment and methods shown in U.S. Pat. No. 11,235,270.

As shown in FIG. 2, the filter media sheet 14 and the pleated layer of filter media 18 thereof may comprises only a single ply of filter media, that may be a homogenous deposition of filter media fibers (e.g., cellulose fibers, polymer/synthetic fibers, glass fibers, additives (binders, adsorbents, adsorbents, etc.), or blends thereof).

Alternatively, as shown in FIG. 8 the filter media sheet 14a and the pleated layer of filter media 18a thereof may be a composite an comprise at least two plies including first and second plies laminated together (for example as illustrated plies 81, 82, 83 laminated together). Plies 81 and 83 are schematically shown to be the same plies of filter media fibers or scrims and may have the same filtration properties (or alternatively different filtration properties if desired), while ply 82 has filter media fibers with different filtration property than plies 81, 83. Each ply may be a deposition of filter media fibers (e.g., cellulose fibers, polymer/synthetic fibers, glass fibers, additives (binders, adsorbents, adsorbents, etc.), or blends thereof), or screens/scrims.

As should be apparent, the embodiment and filter media sheet 14a of FIG. 8 can be used in the embodiments of FIGS. 1-7 for the single ply sheet 14 such that the prior description of FIGS. 1-7 is applicable hereto and vice versa. For example, pleat tips with thicker and thinner portions are also created as shown in the FIG. 8 embodiment similar to the earlier embodiments.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element including a ring of filter media disposed around a central support tube, the filter media comprising a pleated layer of media including inner pleat tips adjacent the tube, and outer pleat tips radially outwardly spaced from the tube, the pleated layer varying in thickness between the tips, such that a thinner portion of media is at the inner pleat tips than as at the outer pleat tips.

2. The filter element of claim 1, wherein pleat scores are at the inner pleat tips and at the outer pleat tips, the thinner portion of media being adjacent to the pleat scores of the inner pleat tips as compared to a thicker portion of media being adjacent to pleat scores of the outer pleat tips.

3. The filter element of claim 2, wherein outside of the pleat scores, the thinner portion has a minimum thickness that is 20% to 90% thinner than a maximum thickness of the thicker portion.

4. The filter element of claim 1, wherein the filter media has a progressively increasing thickness as the filter media extends radially outwardly from the inner pleat tips to the outer pleat tips.

5. The filter element of claim 1, wherein the filter media varies in thickness in a stepped manner as the filter media extends radially outwardly from inner pleat tips to the outer pleat tips.

6. The filter element of claim 1, wherein the thicker portion of media proximate the outer pleat tips includes a portion with a constant unmodified thickness.

7. The filter element of claim 1, wherein a thicker portion of media is provided that is thicker than the thinner portion, the thinner portion being 20% to 90% thinner than a maximum thickness of the thicker portion.

8. The filter element of claim 1, wherein the filter media comprises:
a pleat depth extending between the inner pleat tips and the outer pleat tips between 0.9 and 7.7 centimeters;
a maximum caliper thickness of between 0.2 and 5.1 millimeters; and
wherein the central support tube has an outer diameter of between 1 and 40 centimeters.

9. The filter element of claim 1, wherein the thinner portion remains substantially constant in thickness across a span of the ring of filter media, the span being parallel to the pleat tips.

10. The filter element of claim 1, wherein the filter media is free of embossments, having opposite generally flat surfaces intermediate of the pleat tips.

11. The filter element of claim 1, wherein the thinner portion extends between 5% and 50% of a pleat depth of the pleated layer, and preferably between 10% and 30% of the pleat depth of the pleated layer.

12. The filter element of claim 1, wherein the thinner portion creates space at an inner periphery of the ring to provide larger flow gaps between adjacent inner pleat tips and/or more filter media being used in the ring with more pleats.

13. The filter element of claim 1, wherein the thinner portion merges into the thicker portion as the thinner portion extends radially outwardly perpendicular to the inner pleat tips.

14. A filter media sheet comprising:
a pleated layer of filter media including for pleat tips at opposite first and second flow faces, the pleated layer including a thinner portion of filter media extending from the pleat tips at the first flow face toward the second flow face, and a thicker portion of filter media extending from the pleat tips at the second flow face toward the first flow face, the thicker portion being thicker than the thinner portion.

15. The filter media sheet of claim 14, wherein the thinner portion has a minimum thickness that is 20% to 90% thinner than a maximum thickness of the thicker portion.

16. The filter media sheet of claim 14, wherein pleat scores are provided at the pleat tips, the thinner and thicker portions of the filter media extend from respective pleat scores.

17. The filter media sheet of claim 14, wherein the filter media has a progressively increasing thickness as the filter media extends perpendicularly from the pleat tips at the first flow face to the pleat tips at the second flow face.

18. The filter media sheet of claim 14, wherein the filter media varies in thickness in a stepped manner as the filter media extends perpendicularly from the pleat tips at the first flow face to the pleat tips at the second flow face.

19. The filter media sheet of claim 14, wherein the filter media has a progressively increasing tapered thickness over at least a segment of pleat depth as the filter media extends perpendicularly from the pleat tips at the first flow face to the pleat tips at the second flow face.

20. The filter media sheet of claim 14, wherein the filter media comprises:
a pleat depth extending between the pleat tips at the first and second flow faces of between 0.9 and 7.7 centimeters;
a maximum caliper thickness of between 0.2 and 5.1 millimeters.

21. The filter media sheet of claim 14, wherein the thinner portion remains substantially constant in thickness across a span of the filter media sheet, the span being parallel to the pleat tips.

22. The filter media sheet of claim 14, wherein the filter media is free of embossments, having opposite generally flat surfaces intermediate of the pleat tips.

23. The filter media sheet of claim 14, wherein the thinner portion extends between 5% and 50% of a pleat depth of the pleated layer, and preferably between 10% and 30% of a pleat depth of the pleated layer.

24. A filter element comprising the filter media sheet of claim 14, wherein the filter media sheet wrapped into a ring and defining a central cavity, a radial inner periphery of the ring being provided by the pleat tips at the first flow face and the radial outer periphery of the ring being provided by the pleat tips at the second flow face radially spaced outward from the inner radial periphery.
